(19) United States
(12) Patent Application Publication
(10) Pub. No.: US 2022/0147790 A1
(43) Pub. Date: May 12, 2022

(54) Deep Polynomial Neural Networks

(71) Applicants: Stefanos Zafeiriou, London (GB); Jiankang Deng, London (GB); Stylianos Moschoglou, London (GB); Grigorios Chrysos, Herackion Crete (GR)

(72) Inventors: Stefanos Zafeiriou, London (GB); Jiankang Deng, London (GB); Stylianos Moschoglou, London (GB); Grigorios Chrysos, Herackion Crete (GR)

(21) Appl. No.: 17/194,561

(22) Filed: Mar. 8, 2021

(30) Foreign Application Priority Data
Nov. 11, 2020 (GR) 2020-04302

(51) Int. Cl. G06N 3/04; G06F 17/16

(52) U.S. Cl. CPC G06N 3/04; G06F 17/16

(57) ABSTRACT

This specification relates to polynomial neural networks. In particular, this specification relates to neural networks that use polynomial activation functions. According to one aspect of this specification, there is disclosed a computer implemented method comprising: receiving, as input to a neural network, input data; processing the input data through a plurality of neural network layers of the neural network to generate output data; and outputting, from the neural network, the output data. The plurality of neural network layers comprises a plurality of polynomial layers, each polynomial layer configured to generate one or more polynomials of its respective input, each polynomial layer comprising: one or more product layers, each product layer configured to generate a product of two inputs to said product layer; and one or more additive layers, each additive layer configured to add output of a product layer with output of another layer of the neural network.

### FIELD

This specification relates to polynomial neural networks. In particular, this specification relates to neural networks that use polynomial activation functions.

### BACKGROUND

Neural networks are machine-learning models that employ a series of linear transformations, defined by parameters in the form of weight matrices, followed by non-linear activation functions to predict an output for a received input.

Conventional non-linear activation functions, such as ReLU and tach, are costly to implement on a computer. Additionally, these non-linear functions may not be sufficiently expressive. This may result in difficulties training a neural network using conventional non-linear activation functions, e.g. in situations where the neural network outputs the same value for any input and therefore produces no gradient for learning the parameters of the neural network. Therefore, extensive modifications are usually required when training a neural network with conventional non-linear activation functions.

In addition, the performance of neural networks with conventional non-linear activation functions may be task and/or input dependent, or may require the use of a large number of parameters to achieve a desired level of performance.

### SUMMARY

According to one aspect of this specification, there is disclosed a computer implemented method comprising: receiving, as input to a neural network, input data; processing the input data through a plurality of neural network layers of the neural network to generate output data; and outputting, from the neural network, the output data. The plurality of neural network layers comprises a plurality of polynomial layers, each polynomial layer configured to generate one or more polynomials of its respective input, each polynomial layer comprising: one or more product layers, each product layer configured to generate a product of two inputs to said product layer; and one or more additive layers, each additive layer configured to add output of a product layer with output of another layer of the neural network.

The product layer may comprise a Hadamard layer, each Hadamard layer configured to apply a Hadamard product between a first input to said Hadamard layer and a second input to said Hadamard layer. The neural network may comprises an input layer applying a plurality of linear transformations to the input data. The first input to each Hadamard layer may be a respective linear transformation of the input data.

The plurality of neural network layers may further comprise one or more skip connections between the input layer and a Hadamard layer. The second input to a first Hadamard layer may be a linear transformation of the input data. The second input to one or more subsequent Hadamard layers may be an output of an additive layer. One or more of the skip connections may be between the second input and a subsequent Hadamard layer.

The second input to a first Hadamard layer may be a linear transformation of a first learnable parameter. The second input to one or more subsequent Hadamard layers may be an output of an additive layer. One or more of the additive layers may combine output of a Hadamard layer with a linear transformation of a respective second learned parameter. One or more of the product layers may be further configured to apply a learned linear transformation to output of a Hadamard layer. The plurality of neural network layers may further comprise one or more skip connections between two Hadamard layers.

The neural network may be a generative neural network. The input data may comprise random noise. The output data may comprise an image.

The neural network may be a discriminative neural network. The input data may comprise image data or audio data. The output data may comprise a distribution over image classifications or audio classifications.

The neural network may be a domain adaptive neural network. The input data may comprise a first image from a source domain. The output data may comprise a second image from a target domain.

The neural network may be a mapping neural network configured to generate an embedding vector from the input data. The input data may comprise noise. The output data comprises the embedding vector. The method may further comprises inputting the embedding vector into a synthesis neural network, the synthesis neural network configured to generate a synthesised image in a style conditioned by the input embedding vector and further input noise. The synthesis neural network may comprise: one or more convolutional layers each configured to apply one or more convolutional filters to their respective input; one or more further additive layers, each further additive layer configured to add a linear transformation of further input noise to the output of a convolutional layer; and one or more combining layers, each combining layer configured to combine the output of a further addition layer with a linear transformation of the embedding vector.

According to a further aspect of this specification, there is disclosed a computer implemented method comprising: receiving, as input to a neural network, input data; processing the input data through a plurality of neural network layers of the neural network to generate output data; and outputting, from the neural network, the output data, wherein the plurality of neural network layers comprises one or more product layers, each product layer configured to combine a respective first polynomial of the input data with a respective second polynomial of the input data. The respective first and second polynomials may each be generated using any of the methods/neural networks disclosed herein.

According to a further aspect of this specification, there is disclosed a computer implemented method of training a neural network. The method comprises: receiving, as input to a neural network, input training data; processing the input training data through a plurality of neural network layers of the neural network to generate output data; outputting, from the neural network, the output data; and updating parameters of the neural network in dependence on an objective function, the objective function determined based on the output data. The plurality of neural network layers comprises a plurality of polynomial layers, each polynomial layer configured to generate one or more polynomials of its respective input, each polynomial layer comprising: one or more product layers, each product layer configured to generate a product of two inputs to said product layer; and one or more additive layers, each additive layer configured to add output of a product layer with output of another layer of the neural network.

According to a further aspect of this specification, there is disclosed a system comprising: one or more processors; and one or more non-transitory computer-readable media that collectively store instructions that, when executed by the one or more processors, cause the computing system to perform operations, the operations comprising: receiving, as input to a neural network, input data; processing the input data through a plurality of neural network layers of the neural network to generate output data; and outputting, from the neural network, the output data. The plurality of neural network layers comprises a plurality of polynomial layers, each polynomial layer configured to generate one or more polynomials of its respective input, each polynomial layer comprising: one or more product layers, each product layer configured to generate a product of two inputs to said product layer; and one or more additive layers, each additive layer configured to add output of a product layer with output of another layer of the neural network.

According to a further aspect of this specification, there is disclosed a non-transitory computer readable medium containing instructions thereon which, when executed by one or more computing devices, causes the one or more computing devices to perform a method comprising: receiving, as input to a neural network, input data; processing the input data through a plurality of neural network layers of the neural network to generate output data; and outputting, from the neural network, the output data. The plurality of neural network layers comprises a plurality of polynomial layers, each polynomial layer configured to generate one or more polynomials of its respective input, each polynomial layer comprising: one or more product layers, each product layer configured to generate a product of two inputs to said product layer; and one or more additive layers, each additive layer configured to add output of a product layer with output of another layer of the neural network.

Polynomial layers implemented as described in this specification can provide more expressive neural networks than networks using conventional non-linear activation functions, while also using significantly fewer parameters than conventional neural network layers. In addition, polynomial layers implemented as described in this specification may also scale better to high dimensional signals with complex correlations such as image/video audio data than previous approaches.

Use of polynomial layers in neural networks as described in this specification can achieve superior performance for an inference task (e.g. higher prediction accuracy, higher image generation quality) for a given number of parameters when compared to conventional neural networks.

In other words, to achieve the same level of performance as conventional neural networks, neural networks including polynomial layers as described in this specification may be significantly smaller in terms of number of parameters, thereby reducing the amount of storage required to store the neural network. As a result, inputs to the neural network are processed more quickly, consuming fewer computational resources (e.g. memory and computing power). Additionally, less training data may be required to train neural networks as described in this specification due to the smaller number of parameters.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

Embodiments will now be described by way of non-limiting examples with reference to the accompanying drawings, in which:

FIG. 1 shows an overview of example methods of processing inputs to generate outputs using a neural network comprising a plurality of polynomial layers;

FIG. 2 shows an example network structure of a polynomial neural network;

FIGS. 3a and 3b show further examples of network structures of polynomial neural networks;

FIG. 4 shows an example network structure of a product polynomial neural network;

FIG. 5 shows an example method of using a polynomial neural network for image generation.

FIG. 6 shows a flow diagram of an example method of processing inputs to generate outputs using a neural network comprising a plurality of polynomial layers.

FIG. 7 shows a flow diagram of an example method of training a neural network comprising a plurality of polynomial layers.

FIG. 8 shows a schematic example of a system/apparatus for performing any of the methods described herein.

### DETAILED DESCRIPTION

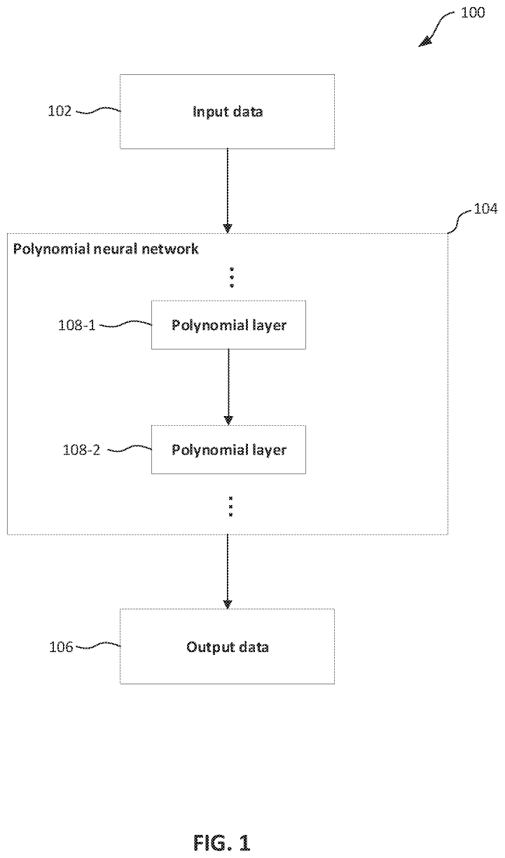

FIG. 1 shows an overview of example method 100 of processing input data 102 to generate output data 106 using a neural network 104 comprising a plurality of polynomial layers 108.

The method processes input data 102 to produce output data 106 using a neural network 104. The input data 102 and output data 106 can be any type of digital data. For example, the neural network 104 may be a generative neural network with the input data 102 being random noise and the output data 106 being an image (or image/video data). As another example, the neural network 104 may be a discriminative neural network, with the input data 102 being image data and/or audio data and the output data 106 being a distribution over image classifications and/or audio classifications. As another example, the neural network 104 may be a domain adaptive neural network with the input data 102 being an image from a source domain and the output data 106 being an image from a target domain. Other combinations of input data 102 and output data 106 are possible, including combinations of different data types to those described above.

The neural network 104 comprises a plurality of polynomial layers 108-1, 108-2. The plurality of polynomial layers 108-1, 108-2 each process a respective input to generate a polynomial output. Each element of the polynomial output is a polynomial of all of the elements of the input into the polynomial layer 108. For example, for a polynomial layer 108 with input z∈ [symbol] ^{d} and output x∈ [symbol] ^{o}, each element of the polynomial output 110 xⱼj∈[1, o] is expressed as a polynomial of input elements z₁, z₂, . . . , z_{d}. Each polynomial layer 108 comprises one or more product layers. Each product layer takes two or more inputs, and outputs a product of those inputs. The product layer may be a Hadamard layer. A Hadamard layer is configured to apply a Hadamard product between two inputs to the Hadamard layer. Other types of product layer, such as matrix multiplication or Khatri-Rao products, may alternatively be used.

Each polynomial layer further comprise one or more additive layers. Additive layers are configured to add the output of a Hadamard layer (or output derived from a Hadamard layer, such as a linear transformation of said output) with output of another layer of the neural network 104. In various embodiments, one or more additive layers may be configured to implement a skip connection by adding together output of a network layer and input of an earlier layer in the network 104.

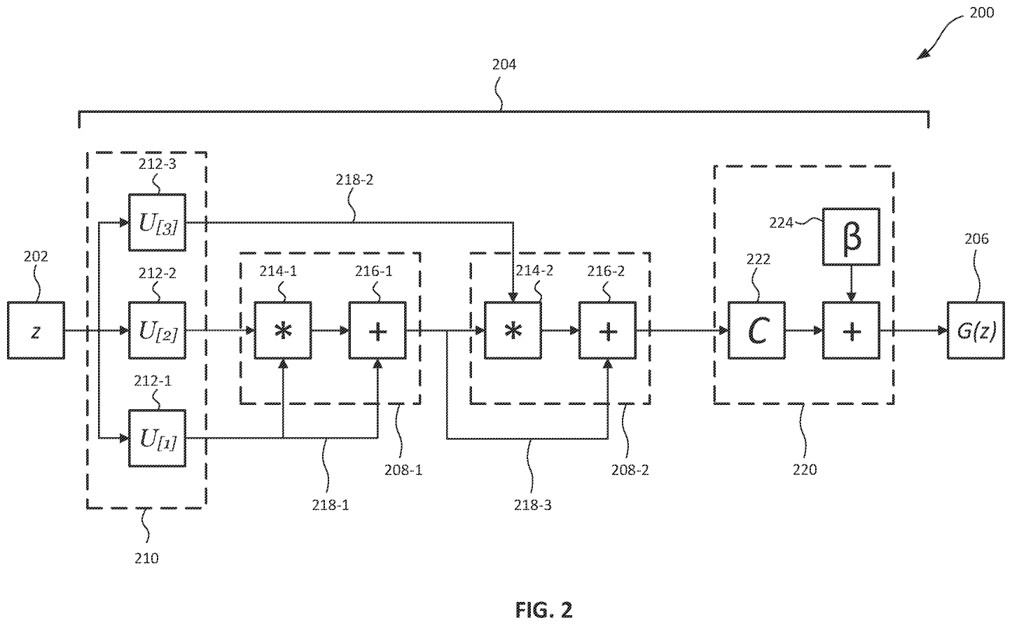

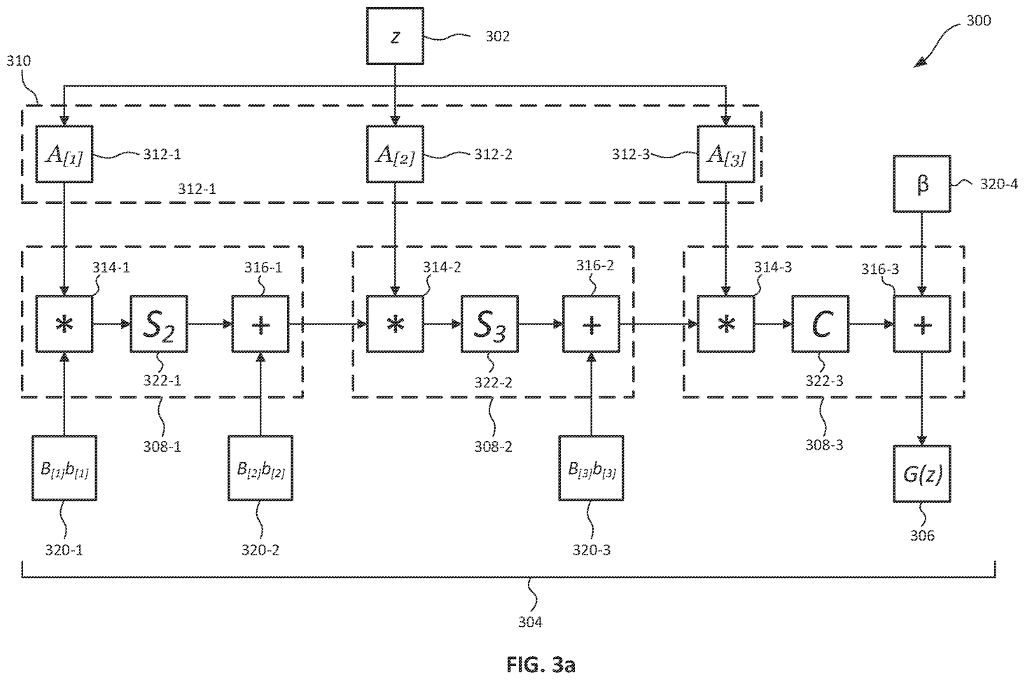

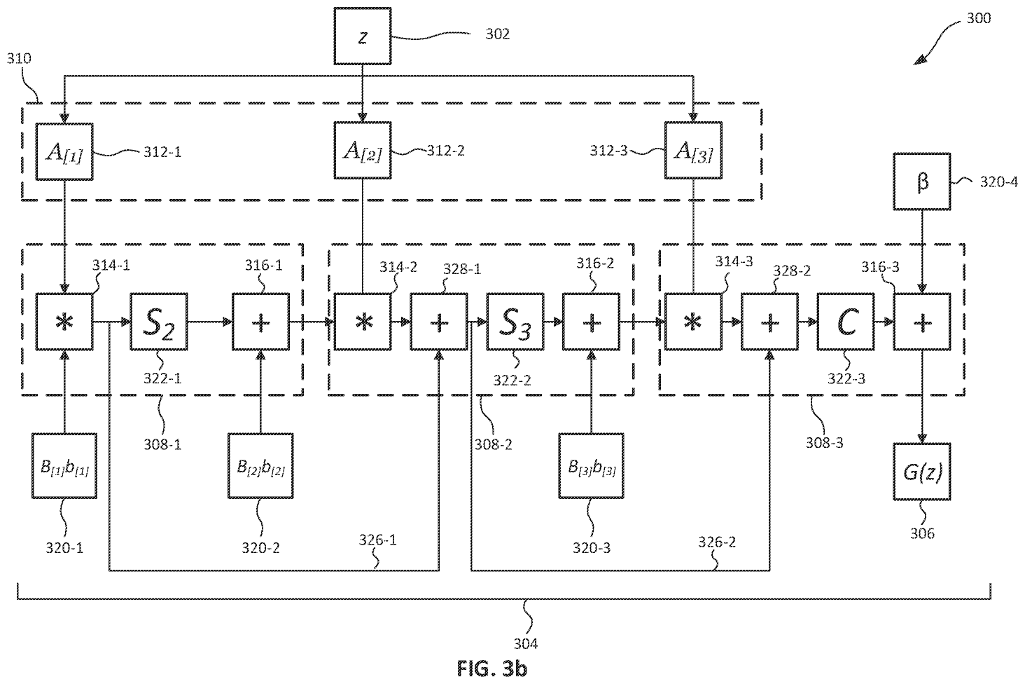

In various embodiments, higher order polynomials may be produced from lower order polynomials. For example, a polynomial mapping may be generated by a recursive relationship, with each element of the recursive sequence determined based on an output of a polynomial layer. Each element of the sequence may produce a polynomial with a higher order than the previous element of the sequence. Examples of embodiments using recursive relationships are described in relation to FIGS. 2, 3a and 3b.

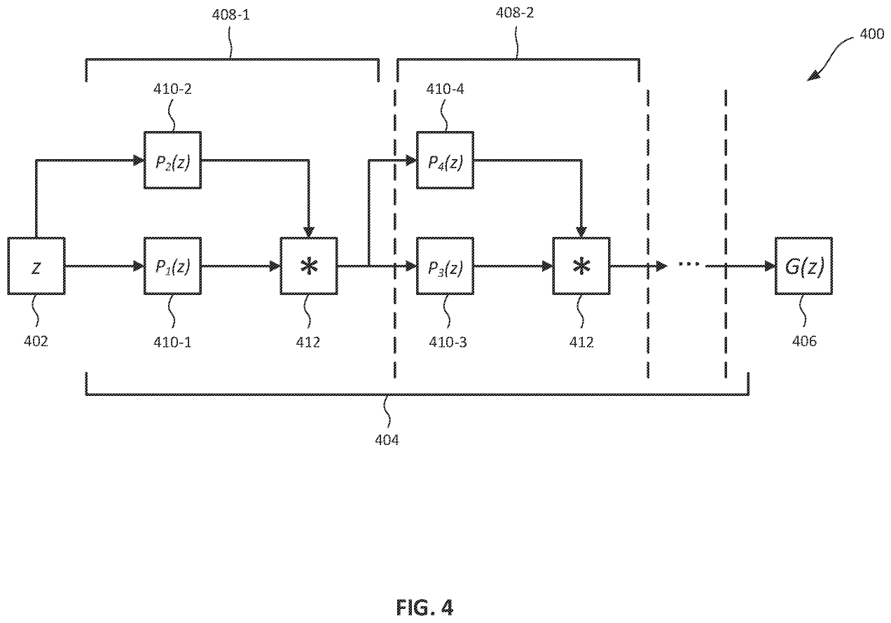

Additionally or alternatively, higher order polynomial layers may be produced from the product of lower order polynomial layers. In these embodiments, the lower degree polynomials themselves may be produced using a recursive relationship (as described above) or otherwise. Examples of embodiments using products of polynomial layers are described in relation to FIG. 4.

FIG. 2 shows an example network structure 200 for processing input data 202 to generate output data 206 using a polynomial neural network 204 comprising a plurality of polynomial layers 208.

The input data 202, denoted by z, may be represented as a vector, a matrix/array or a higher order tensor. The input data 202 may comprise: pixel values of an image (e.g. RGB values); audio data; and/or noise. The input data 202 may be the output of a preceding neural network/neural network layer. The polynomial neural network 202 processes the input data 202 to generate output data 206 that comprises one or more polynomial functions of the input data 202. The output data may comprise a scalar value; a vector (for example representing a distribution over a set of classifications of the input data 202); a matrix/array; and/or a tensor (for example representing pixel values of an output image). The output data 206 may be used as input for a subsequent neural network/neural network layer.

The polynomial neural network 204 comprises an input layer 210 configured to apply a plurality of linear transformations 212 to the input data 202. In the example shown, three linear transformations, denoted U_{[1]}, U_{[2]} and U_{[3]}, are each applied to the input data 202. However, it will be appreciated that a lower or greater number of linear transformations may be applied in the input layer 210. Each linear transformation is defined by a plurality of parameters. For example, the linear transformation 212 may be defined by a plurality of matrix elements of a matrix multiplying the input data 202 and/or a plurality of vector components that are added to the input data 202. The linear transformation 212 may comprise an addition/subtraction of a vector/matrix/tensor, a matrix/tensor multiplication, a Hadamard product of a matrix/tensor with the input data 202, a convolution operation or any other suitable linear transformation. A plurality of the parameters of the linear transformations 212 may be learned during training of the polynomial neural network 204.

Each of the plurality of polynomial layers 208 comprises one or more Hadamard layers 214, denoted by a “*” in the figures. Each Hadamard layer 214 is configured to apply a Hadamard product between a first input to said Hadamard layer and a second input to said Hadamard layer. In general, the Hadamard layers take as input a first polynomial function of the input data 202 of order n (also referred to herein as the first input to the Hadamard layer) and a second polynomial function of the input data 202 of order m (also referred to herein as the second input to the Hadamard layer) and outputs a polynomial function of the input data of order n+m by applying a Hadamard product between the first polynomial function and the second polynomial function. The first input to each Hadamard layer 214 is, in the example shown, a respective linear transformation 212 of the input data 202. The second input to a Hadamard layer 214 may be a further linear transformation 212 of the input data 202, as shown in the first Hadamard layer 214-1 of FIG. 2. Alternatively, the second input to a Hadamard layer 214 may be an output of a previous layer of the polynomial neural network, as shown in the second 214-2 Hadamard layer of FIG. 2.

Each polynomial layer further comprises one or more additive layers 216. Each additive layer 216 is configured to add output of a Hadamard layer 214 with output of another layer of the polynomial neural network 204. In general, an additive layer 216 takes as a first input a first polynomial function of the input data 202 of order p (also referred to herein as the first input to the additive layer) and a second polynomial function of the input data 202 of order q (also referred to herein as the second input to the additive layer) and outputs a polynomial function of the input data of order Max(p, q) by adding the first and second inputs. Output of an additive layer 216-1 can be used as a second input to a Hadamard layer 214-2.

The neural network 204 may further comprise one or more skip connections 218. The skip connections 218 take an output of a given network layer and use it as input for a subsequent layer of the network that is not the layer immediately following the given network layer, i.e. it skips one or more of the layers of the network 204. Several examples of skip connections 218 are shown in FIG. 2. In one example, first output of the input layer (U_{[1}]z) is input into the first additive layer 216-1 via a skip connection 218-1. In a further example, third output of the input layer 203 (U_{[3]}z) is input into the second Hadamard layer 216-1 via a skip connection 218-2, skipping the first polynomial layer 208-1. In yet a further example, output of the first additive layer 216-1 is input into the second additive layer 216-2 via a skip connection 218-3, skipping the second Hadamard layer 214-2.

The neural network 204 may further comprise an output layer 220 configured to generate the output data 206 from output of a final polynomial layer 208-2. The output layer is configured to apply a learned linear transformation to the output of the final polynomial layer 208-2. The linear transformation may, for example, comprise multiplying output of the final polynomial layer 208-2 with a matrix 222 of learned elements, C, (for example, using matrix multiplication or a Hadamard product). The linear transformation may alternatively or additionally comprise adding a vector 224 of learned components, β. Other types of linear transformation may be applied. The type of linear transformation applied may depend on the form of the output of the final polynomial layer 208-2.

For illustrative purposes, the following description provides an example method of using neural network 204 to produce a third order output polynomial 216, G(z), of the input 202, z, by a recursive relationship using the polynomial layers 208, although it will be appreciated that a polynomial of any order may be produced by increasing the number of polynomial layers 208 in the polynomial neural network 202.

As described above in relation to FIG. 1, a polynomial mapping of input data 202 to output data 206 may be generated using a recursive relationship, with each element of the recursive sequence determined based on an output of a polynomial layer 208. For input data 202 denoted z∈ [symbol] ^{d}, output data 206 denoted x∈ [symbol] ^{o}, initial term x₁=(U_{[1]}^{T}z), and * denoting the Hadamard product, an example recursive relationship to produce polynomial G(z) of the input by neural network 204 of order N may be given as

xₙ=(U_{[n]}^{T}z)*xₙ₋₁+xₙ₋₁

G(z)=Cx_{N}+β

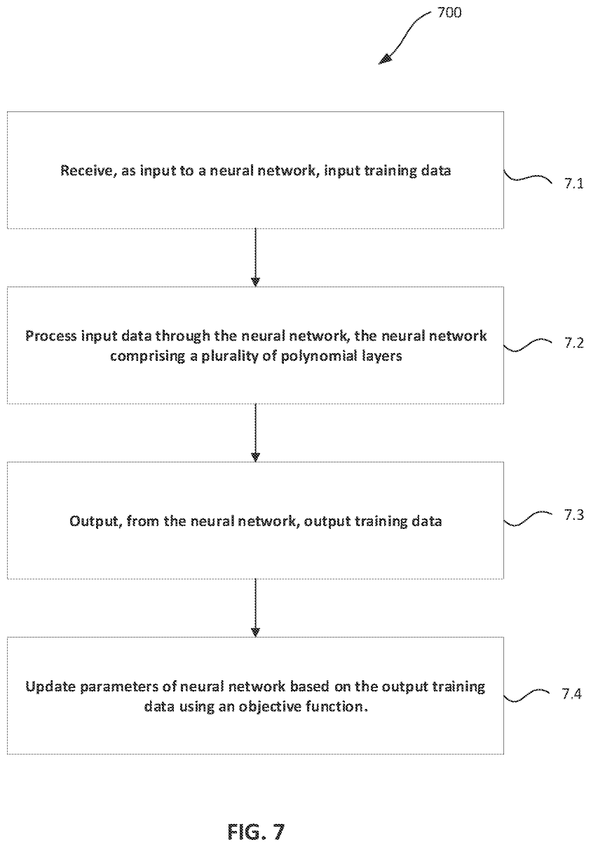

The variables U_{[n]}, C, β each comprise a plurality of parameters that are learnable during training of the neural network 204, as will be discussed in further detail in relation to FIG. 7. The example shown in FIG. 2 generates a third order polynomial, though it will be appreciated that different order polynomials may be generated by varying the number of polynomial layers 208.

In the example provided in FIG. 2, the neural network 204 receives input data 202, z. The input data 202 is processed by the input layer 210 comprising a plurality of linear transformations 212-1, 212-2, 212-3 to respectively produce first, second and third linear outputs U_{[1]}^{T}z, U_{[2]}^{T}, U_{[3]}^{T}z. The initial term x₁=(U_{[1]}^{T}z) of the recursive relationship is produced by the first linear output produced by linear transformation 212-1.

A first Hadamard layer 214-1 receives two inputs produced by the input layer 210 to produce a first polynomial output of the input data 202. The first polynomial output is produced by applying a Hadamard product between the first and second linear outputs produced by linear transformations 212-1 and 212-2. Thus, the first Hadamard layer 214-1 thus computes (U_{[1]}^{T}z)·(U_{[2]}^{T}z) as the first polynomial output.

A first additive layer 216-1 is configured to produce a second element of the recursive relationship. The first additive layer 216-1 is configured to add together the first polynomial output produced by the first Hadamard layer 214-1 with the first linear output of linear transformation 212-1. A skip connection 218-1 is used to input the first linear output of the input layer 210 into the first additive layer 216-1. The first additive layer 212-1 thus computes (U_{[1]}^{T}z*U_{[2]}^{T}z)+U_{[1]}^{T}z, i.e. the second element in the recursive relationship, which is denoted by x₂.

The second Hadamard layer 214-2 receives the third linear output produced by linear transformation 212-3 (via skip connection 218-2) and the output of additive layer 216-1 to produce a second polynomial output of the input data 202. The second polynomial output is produced by applying a Hadamard product between the third linear output and the output of additive layer 212-2. The second Hadamard layer thus computes U_{[3]}^{T}z*x₂.

The second additive layer 216-2 generates the third element of the recursive relationship from the output of the second Hadamard layer 214-2 and the output of the first additive layer 216-1 (i.e. x₂). Additive layer 216-2 is configured to add together the second polynomial output produced by the second Hadamard layer 214-2 with the output of the first additive layer 216-1. A skip connection 218-3 is used to input the output of the first additive layer 216-1 into the second additive layer 216-2. The second additive layer 216-2 thus computes (U_{[3]}^{T}z*x₂)+x₂, i.e. the third element in the recursive relationship, which is denoted by x₃.

The output third order polynomial 206 is produced by applying a linear transformation 220 to the output of the second additive layer 216-2. For example, the output 206 may be determined as Cx₃+β. Alternatively, the output may be determined by any linear transformation of the output of second additive layer 216-2, e.g. a Hadamard product or a convolution. In some embodiments, the linear transformation 220 may be omitted.

FIG. 3a shows a further example of a neural network structure 300 for processing inputs 302 to generate outputs 306 using a polynomial neural network 304 comprising a plurality of polynomial layers 308.

The neural network 304 comprises an input layer 310 configured to apply a plurality of linear transformations 312 to the input data 302. Each of the plurality of polynomial layers 308 comprises one or more Hadamard layers 314, each Hadamard layer 314 configured to apply a Hadamard product between a first input to said Hadamard layer and a second input to said Hadamard layer. The first input to each Hadamard layer 314 is a corresponding linear transformation 312 of the input data 302 output by the input layer 310. The Hadamard layers operate as described in relation to FIG. 2, though have different inputs in this embodiment.

Each polynomial layer 308 further comprises one or more additive layers 316, each additive layer 316 configured to add an auxiliary parameter 320 to output of a previous layer of the neural network 304. One or more of the auxiliary parameters 320 may each be generated by applying a linear transformation, B_{[n]}, to a learnable input vector, b_{[n]}. One or more of the auxiliary parameters may be a learned constant vector, β.

The polynomial layers 308 each further comprise a linear layer 324. Each linear layer 322 is configured to apply a learned linear transformation, S_{[n]}, C, to the output of a Hadamard layer 214 prior to its input into an additive layer 216.

For illustrative purposes, the following description provides an example method of using neural network 304 to produce a polynomial 306 of the input 302 of order N by a recursive relationship using the outputs of the polynomial layers 308. In the example of FIG. 3a, a third order polynomial is produced, although it will be appreciated that a polynomial of any order may be produced by altering the number of polynomial layers 308 in the polynomial neural network 304.

For input data 302 denoted z∈ [symbol] ^{d}, output data 316 denoted x∈ [symbol] ^{o}, initial term x₁=(A_{[1]}^{T}z)*(B_{[1]}^{T}b_{[1]}), and * denoting the Hadamard product, an example recursive relationship to produce a third order polynomial G(z) of the input by neural network 304 may be given as

xₙ=(A_{[n]}^{T}z)*(S_{[n]}^{T}xₙ₋₁+B_{[n]}^{T}b_{[n]})

G(z)=Cx_{N}+β

The variables A_{[n]}, S_{[n]}, B_{[n]}, b_{[n]}, C, β each comprise a plurality of parameters that are learnable during training of the neural network 204, as discussed in further detail in relation to FIG. 7.

In the example provided in FIG. 3, the neural network 304 receives input data 302, z. The input data 302 is processed by the input layer 310 comprising a plurality of linear transformations 312-1, 312-2, 312-3 to respectively produce first, second and third linear outputs A_{[1]}^{T}z, A_{[2]}^{T}z, A_{[3]}^{T}z. The neural network 304 additionally applies a first, second, and third linear transformation, B_{[n]}, to first, second and third learnable input parameters, b_{[n]}, respectively to generate first, second and third auxiliary parameters 320-1, 320-2, 320-3, denoted B_{[1]}^{T}b_{[1]}, B_{[2]}^{T}b_{[2]}, B_{[3]}^{T}b_{[3]}.

The first Hadamard layer 314-1 is configured to produce the initial term of the recursive relationship. The first Hadamard layer 314-1 receives the first linear output of the input layer 310 and the first auxiliary parameter 320-1 to produce a first polynomial output. The first polynomial output is produced by applying a Hadamard product between the first linear output produced by linear transformation 310-r and the first auxiliary parameter 320-1. The first Hadamard layer 314-1 thus computes (A_{[1]}^{T}z)*(B_{[1]}^{T}b_{[i]}), i.e. the first term of the recursive relationship, which may be denoted by x₁. A first learned linear transformation 322-1, S_{[2]}, is then applied to the output of the first Hadamard layer 314-1 to give a first transformed Hadamard output, S_{[2]}^{T}x₁.

A first additive layer 316-1 combines the output of the first learned linear transformation 322-1 with a second auxiliary parameter 320-2. In other words, the first additive layer 316-1 is configured to compute S_{[2]}^{T}x₁+B_{[2]}^{T}b_{[2]}.

A second Hadamard layer 314-2 is configured to produce a second polynomial output from the output of the first additive layer 316-1 and the second linear output produced by linear transformation 312-2 by the input layer 310. The second polynomial output is produced by applying a Hadamard product between the second linear output produced by linear transformation 312-2 and the output of first additive layer 316-1. The second Hadamard layer 314-2 thus computes (A_{[2]}^{T}z)*(S_{[2]}^{T}x₁+B_{[2]}^{T}b_{[2]}), which is denoted by x₂. A second learned linear transformation 322-2, S_{[3]}, is then applied to the output of the second Hadamard layer 314-2 to give a second transformed Hadamard output, S_{[3]}^{T}x₂.

A second additive layer 316-2 combines the output of the second learned linear transformation 322-2 with a third auxiliary parameter 320-3. In other words, the first additive layer 316-3 is configured to compute S_{[3]}^{T}x₂+B_{[3]}^{T}b_{[3]}.

A third Hadamard layer 310-3 is configured to produce a third element of the recursive relationship. The third Hadamard layer 310-3 receives the third linear output produced by linear transformation 308-3 and the output of second additive layer 312-2 to produce a third polynomial output.

The third polynomial output is produced as a result of a Hadamard product applied to the third linear output produced by linear transformation 308-3 and the output of second additive layer 312-2. For example, the third Hadamard layer 310-3 may be configured to compute (A_{[3]}^{T}z)*(S_{[3]}^{T}x₂+B_{[3]}^{T}b_{[3]}), which may be denoted by x₃.

A third Hadamard layer 314-3 is configured to produce a third polynomial output from the output of the second additive layer 316-2 and the third linear output produced by linear transformation 312-3 of the input data 302 by the input layer 310. The third polynomial output is produced by applying a Hadamard product between the third linear output produced by linear transformation 312-3 and the output of second additive layer 316-2. The third Hadamard layer 314-3 thus computes (A_{[3]}^{T}z)*(S_{[3]}^{T}x₂+B_{[3]}^{T}b_{[3]}), which is denoted by x₃. A third learned linear transformation 322-3, C, is then applied to the output of the third Hadamard layer 314-3 to give a third transformed Hadamard output, Cx₃.

A final additive layer 316-3 adds a fourth auxiliary parameter 320-4 to the third transformed Hadamard output to generate the final term in the recursive relationship. This is output as the output data 306.

FIG. 3b shows a further example of a neural network structure for processing input data 302 to generate output data 306 using a neural network 304 comprising a plurality of polynomial layers 308.

The network structure of FIG. 3a may be adapted to provide for one or more skip connections 326 between output of layers in the network and inputs of further additive layers 328. The addition of skip connections 326 and further additive layers 328 produces a different recursive relationship to the network shown in FIG. 3a. The recursive relationship used to generate a third order polynomial using the network of FIG. 3b may be given as

xₙ=(A_{[n]}^{T}z)*(S_{[n]}^{T}xₙ₋₁+B_{[n]}^{T}b_{[n]})+xₙ₋₁

G(z)=Cx₃+β

It will be appreciated that this recursive relationship may be extended to higher orders by adding further polynomial layers 308 to the network 304.

FIG. 4 shows an example of a further polynomial neural network structure. The polynomial neural network 404 receives input data 402, z, and processes the input data through a plurality of polynomial layers 408 to generate output data 406, G(z). In these examples, instead of using a single polynomial, the output function 406 is expressed as a product of polynomials, and is referred to herein as a product polynomial network.

The product is implemented as successive polynomials where the output of the i^{th} polynomial is used as the input for the p=i+1^{th} polynomial. If each polynomial is of order B and N such polynomials are stacked in the network, the order of the output is B^{N}. However, the product does not necessarily demand the same order in each polynomial. The expressivity and the expansion order of each polynomial can be different and dependent on the task, e.g. for generative tasks in which the resolution increases progressively, the expansion order may increase in the last polynomials of the network. However, the final order will be the product of each polynomial.

Each polynomial layer comprises two or more sub-networks 410, each configured to generate one or more polynomials, Pᵢ(z), of their respective input data. The generated polynomials may be a scalar, a vector of polynomials, a matrix of polynomials or a higher order tensor of polynomials. The sub-networks 410 may, for example, each be one of the networks described above in relation to FIGS. 1-3. The sub-networks may each have an identical network structure (though may in general have different learned parameters). For example, each sub-network in a polynomial layer 408 may have the structure of the network described in relation to one of FIGS. 2-3. Each sub-network in a polynomial layer 408 may have a different structure. For example, a first sub-network 410-1, 410-3 in a polynomial layer 408 may have the structure of the network described in relation to FIG. 2, while a second sub-network 410-2, 410-4 in said polynomial layer 408 may have the network structure defined in relation to FIG. 3a or 3b.

Each polynomial layer 408 further comprises a product layer 412. Each product layer 412 generates a product of the polynomials output by the sub-networks 410 of its polynomial layer 408. The product may be a Hadamard product of the output polynomials. Other products, such as matrix/tensor multiplication or Khatri-Rao products may alternatively be used.

Each polynomial layer 408 in the network may have the same structure. That is, the first sub-network 410-1 of the first polynomial layer 408-1 may have the same network structure as the first sub-network 410-3 of subsequent polynomial layers 408-2. The second sub-network 410-2 of the first polynomial layer 408-1 may have the same network structure as the second sub-network 410-4 of subsequent polynomial layers 408-2. Alternatively, one or more of the polynomial layers 408 may have a different structure to one or more of the other polynomial layers 408 in the network.

Such product polynomial networks may provide further advantages over the “single polynomial” examples described in relation to FIGS. 1-3. The use of product polynomial networks can enable different decompositions of the output function 406 and different expressive powers for each polynomial to be used. The use of product polynomial networks can also require fewer parameters for achieving the same accuracy.

A comparison of the performance of an example of a product polynomial network (ProdPoly) to a more conventional neural network (in this case ResNet34) for the task of speech recognition is shown in Table 1. The number of parameters required for the same level of accuracy is significantly fewer for the product polynomial network, which can reduce the amount of memory required to store the network and the amount of time required to train the network.

TABLE 1
Speech Commands classification with ResNet

| Model | Number of parameters | Accuracy |
|---|---|---|
| ResNet34 | 21.3 million | 0.951 ± 0.002 |
| Prodpoly | 13.2 million | 0.951 ± 0.002 |

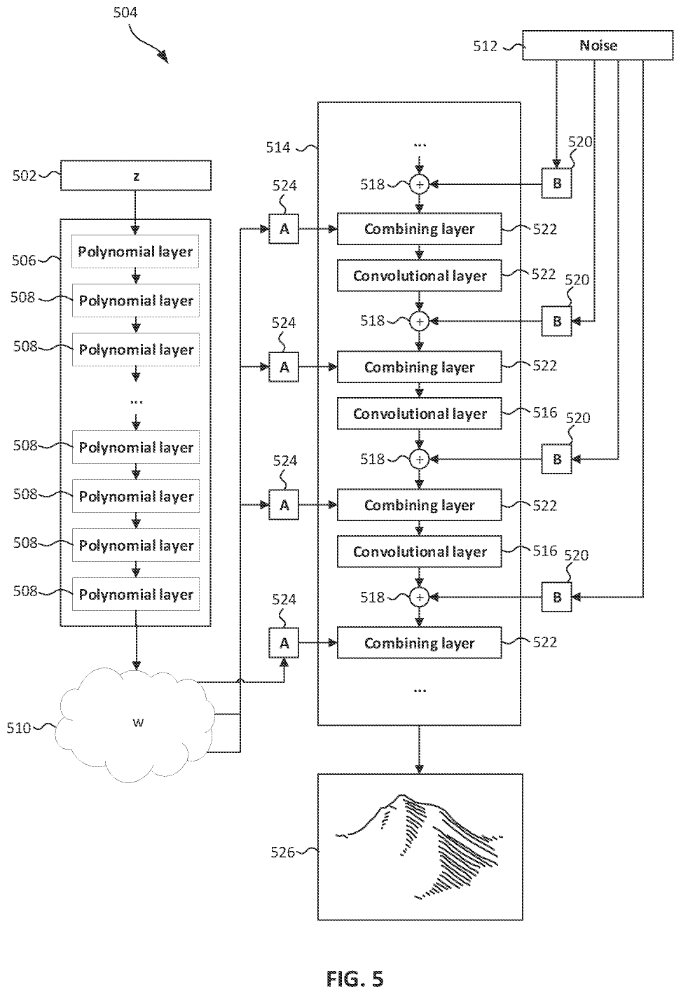

FIG. 5 shows an example neural network 504 structure for image generation. The method may be performed by one or more computers. The neural network 504 comprises a mapping neural network 506 configured to generate an embedding vector 510 from input data 502, and a synthesis network 514 configured to generate a synthesised image 526 in a style conditioned by the input embedding vector 510 and input noise 512.

The mapping neural network 506 is a neural network comprising a plurality of polynomial layers 508, such as the polynomial neural networks layers described in relation to FIGS. 1-4.

The synthesis neural network 514 comprises one or more convolutional layers 516 each configured to apply one or more convolutional filters to their respective input; one or more addition layers 518, each addition layer configured to add a linear transformation 520, B, of input noise 512 to the output of a convolutional layer 516; and one or more combining layers 522, each combining layer 522 configured to combine the output of a further addition layer 518 with a linear transformation 524, A, of the embedding vector 510. The synthesis neural network may, for example, have the structure of the synthesis network StyleGAN, described in “A style-based generator architecture for generative adversarial networks” (T. Karras et al., IEE Proceedings of International Conference on Computer Vision and Pattern Recognition, 2019, the contents of which are incorporated herein by reference).

As described above in relation to FIGS. 1-4, higher order polynomials may be produced by a product of lower order polynomials. For example, a neural network comprising a plurality of polynomial layers can further include combining layers, each combining layer configured to combine a respective first polynomial of the input data with a respective second polynomial of the input data. The combining layer may combine two polynomial layers by providing the output of a first polynomial as the input to a second polynomial layer. For example, if the first polynomial processes input z to produce a polynomial output G₁(z), instead of configuring the second polynomial layer to also process z, the second polynomial layer may process G₁(z) by computing G₂(G₁(z)).

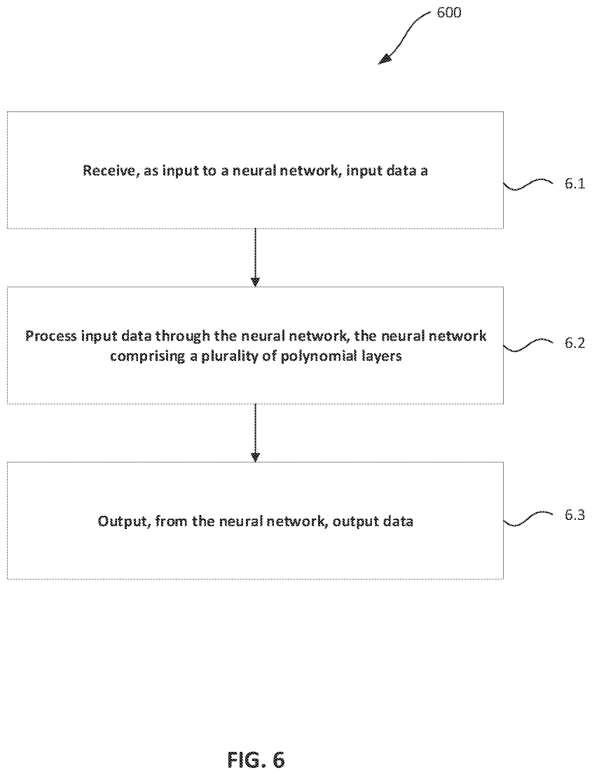

FIG. 6 shows a flow diagram of an example method 600 of processing inputs to generate outputs using a neural network comprising a plurality of polynomial layers. The flow diagram corresponds to the methods described above in relation to FIGS. 1-5.

At operation 6.1, the input data is received as input to the neural network. The input data can be any type of digital data. For example, the input data can be image data, video data, audio data, random noise and/or an image from a source domain. The input data may be a combination of different types of digital data. The input data may be in the form of a vector, a matrix or a higher order tensor.

The neural network comprises a plurality of neural network layers including a plurality of polynomial layers, each polynomial layer configured to generate a polynomial of its respective input. Each polynomial layer comprises one or more product layers and one or more additive layers. Each product layer receives two or more sets of data as input, and generates a product of the two or more sets of input data. Each additive layer configured to add output of a product layer with output of another layer of the neural network.

In various embodiments, the product layers comprise one or more Hadamard layers, each Hadamard layer configured to apply a Hadamard product between a first input to said Hadamard layer and a second input to said Hadamard layer. The neural network may further comprise an input layer applying a plurality of linear transformations to the input data. The first input to each Hadamard layer may be a respective linear transformation of the input data.

At operation 6.2, the input data is processed through the plurality of neural network layers of the neural network to generate output data.

The output data can be any type of digital data. For example, the output data can be image data, video data, audio data, a distribution over image classifications, a distribution over audio classifications, and/or an image from a target domain. The output data may be a combination of different types of digital data.

At operation 6.3, the output data is output by the neural network. The output data may undergo further processing, for example in another neural network.

FIG. 7 shows a flow diagram of an example method 700 of training a neural network comprising a plurality of polynomial layers. The flow diagram corresponds to methods of training neural networks described above in relation to FIGS. 1-5.

At operation 7.1, input training data is received as input to the neural network. The input training data may comprise one or more examples of training data. The one or more examples of training data can be any type of digital data. For example, the input data can be image data, video data, audio data, random noise and/or an image from a source domain. The input data may be a combination of different types of digital data. The input data may be in the form of a vector, a matrix or a higher order tensor.

The neural network comprises a plurality of neural network layers including a plurality of polynomial layers, each polynomial layer configured to generate a polynomial of its respective input. Each polynomial layer comprises one or more product layers and one or more additive layers. Each product layer receives two or more sets of data as input, and generates a product of the two or more sets of input data. Each additive layer configured to add output of a product layer with output of another layer of the neural network.

In various embodiments, the product layers comprise one or more Hadamard layers, each Hadamard layer configured to apply a Hadamard product between a first input to said Hadamard layer and a second input to said Hadamard layer. The neural network may comprise an input layer applying a plurality of linear transformations to the input data. The first input to each Hadamard layer may be a respective linear transformation of the input data.

At operation 7.2, the input training data is processed through a plurality of neural network layers of the neural network to generate output data. The output data may comprise an output for each training example of the one or more training examples. The output data can be any type of digital data. For example, the output data can be image data, video data, audio data, a distribution over image classifications, a distribution over audio classifications, and/or an image from a target domain. The output data may be a combination of different types of digital data.

At operation 7.3, the output data is output by the neural network.

At operation 7.4, the parameters of the neural network are updated in dependence on an objective function. The particular objective function used is dependent on the type of task that the network is being trained to perform. The value objective function may be determined based on a plurality of output data generated by iterating operations 7.1-7.3 over a batch of training data.

Operations 7.1 to 7.4 may be iterated until a termination condition is satisfied. The termination condition may, for example, be a threshold number of iterations/training epochs; a threshold accuracy of the network being reached; and/or a convergence criterion of the objective function.

Generally, the neural network is trained to optimise an objective function. The parameters of the neural network may be updated using an optimisation procedure in order to determine a setting of the parameters that substantially optimise (e.g. minimise or maximise) the objective function. The optimisation procedure may use gradients of the objective function with respect to parameters of the neural network. The optimisation procedure may be based on stochastic gradient descent/ascent, mini-batch gradient descent/ascent or batch gradient descent/ascent.

In generative tasks (such as image generation), an adversarial objective function may be used. A generator neural network and a discriminator neural network are jointly trained using the adversarial objective function. The generator neural network may be a polynomial network, with the discriminator neural network being a standard neural network. The generator is trained to generate “false” data from, for example, input noise, with the goal of fooling the discriminator, while the discriminator is trained to distinguish between real and fake data.

As a further example, in classification tasks (such as image classification or speech recognition), a classification loss may be used to compare the output data with a known classification of the input data. Examples of classification losses include, but are not limited to; cross entropy; logistic losses; exponential losses; square losses; and/or tangent losses.

As an example, the polynomial neural network model may be trained for image classification. Following standard practices, the following data augmentation techniques may be performed during the training: (1) normalization through mean RGB-channel subtraction, (2) random crop to 224×224, (3) scaling from 5% to 100%, (4) aspect ratio from 3/4 to 4/3, and/or (5) random horizontal flip. The model may be trained on a DGX station with 4 Tesla V100 (32 GB) GPUs. Mxnet is used to train the network, with float16 chosen instead of float32 to achieve 3.5× acceleration and half the GPU memory consumption. To stabilize the training, the second order of each residual block may be normalized with a hyperbolic tangent unit. The SGD with momentum 0.9, weight decay 10−⁴ and a mini-batch size of 1024 is used. The initial learning rate is set to 0.4 and decreased by a factor of 10 at 30, 60, and 80 epochs. The model is trained for 90 epochs from scratch, using linear warm-up of the learning rate during first five epochs. For other batch sizes, due to the limitation of GPU memory the learning rate may be linearly scaled (e.g. 0.1 for batch size 256). During inference, the input data may be pre-processed by: (1) normalization through mean RGB-channel subtraction, (2) scaled to 256×256, and (3) single centre cropped to 224×224.

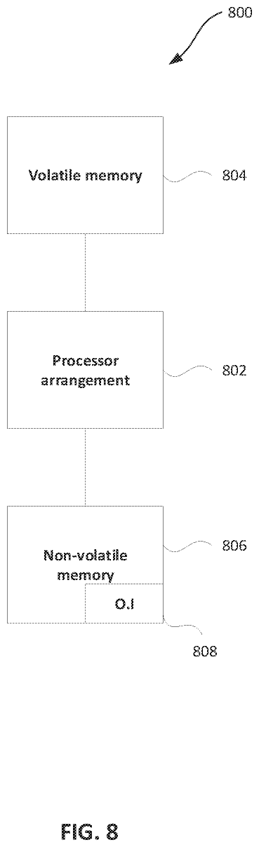

FIG. 8 shows a schematic example of a system/apparatus for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 800 comprises one or more processors 802. The one or more processors control operation of other components of the system/apparatus 800. The one or more processors 802 may, for example, comprise a general purpose processor. The one or more processors 802 may be a single core device or a multiple core device. The one or more processors 802 may comprise a Central Processing Unit (CPU) or a Graphical Processing Unit (GPU). Alternatively, the one or more processors 802 may comprise specialised processing hardware, for instance a RISC processor or programmable hardware with embedded firmware. Multiple processors may be included.

The system/apparatus comprises a working or volatile memory 804. The one or more processors may access the volatile memory 804 in order to process data and may control the storage of data in memory. The volatile memory 804 may comprise RAM of any type, for example Static RAM (SRAM), Dynamic RAM (DRAM), or it may comprise Flash memory, such as an SD-Card.

The system/apparatus comprises a non-volatile memory 806. The non-volatile memory 806 stores a set of operation instructions 808 for controlling the operation of the processors 802 in the form of computer readable instructions. The non-volatile memory 806 may be a memory of any kind such as a Read Only Memory (ROM), a Flash memory or a magnetic drive memory.

The one or more processors 802 are configured to execute operating instructions 708 to cause the system/apparatus to perform any of the methods described herein. The operating instructions 808 may comprise code (i.e. drivers) relating to the hardware components of the system/apparatus 800, as well as code relating to the basic operation of the system/apparatus 800. The one or more processors 802 execute one or more instructions of the operating instructions 808, which are stored permanently or semi-permanently in the non-volatile memory 806, using the volatile memory 804 to store temporarily data generated during execution of said operating instructions 808.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 8, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims and any equivalents thereof.

1. A computer implemented method comprising:
receiving, as input to a neural network, input data;
processing the input data through a plurality of neural network layers of the neural network to generate output data; and
outputting, from the neural network, the output data,
wherein the plurality of neural network layers comprises a plurality of polynomial layers, each polynomial layer configured to generate one or more polynomials of its respective input, each polynomial layer comprising:
one or more product layers, each product layer configured to generate a product of two inputs to said product layer; and
one or more additive layers, each additive layer configured to add output of a product layer with output of another layer of the neural network.

2. The method of claim 1, wherein the product layer comprises a Hadamard layer, each Hadamard layer configured to apply a Hadamard product between a first input to said Hadamard layer and a second input to said Hadamard layer.

3. The method of claim 2, wherein:
the neural network comprises an input layer applying a plurality of linear transformations to the input data; and
the first input to each Hadamard layer is a respective linear transformation of the input data.

4. The method of claim 3, wherein:
the plurality of neural network layers further comprises one or more skip connections between the input layer and a Hadamard layer; and
the second input to a first Hadamard layer is a linear transformation of the input data.

5. The method of claim 4, wherein the second input to one or more subsequent Hadamard layers is an output of an additive layer, and wherein one or more of the skip connections is between the second input and a subsequent Hadamard layer.

6. The method of claim 3, wherein the second input to a first Hadamard layer is a linear transformation of a first learnable parameter.

7. The method of claim 6, wherein:
the second input to one or more subsequent Hadamard layers is an output of an additive layer; and
one or more of the additive layers combines output of a Hadamard layer with a linear transformation of a respective second learned parameter.

8. The method of claim 7, wherein one or more of the product layers is further configured to apply a learned linear transformation to output of a Hadamard layer.

9. The method of claim 7, wherein:
the plurality of neural network layers further comprises one or more skip connections between two Hadamard layers.

10. The method of claim 1, wherein;
the neural network is a generative neural network;
the input data is random noise; and
the output data is an image.

11. The method of claim 1, wherein;
the neural network is a discriminative neural network;
the input data is image data or audio data; and
the output data is a distribution over image classifications or audio classifications.

12. The method of claim 1, wherein;
the neural network is a domain adaptive neural network;
the input data is a first image from a source domain; and
the output data is a second image from a target domain.

13. The method of claim 1, wherein:
the neural network is a mapping neural network configured to generate an embedding vector from the input data;
the input data is noise; and
the output data comprises the embedding vector,
wherein the method further comprises inputting the embedding vector into a synthesis neural network, the synthesis neural network configured to generate a synthesised image in a style conditioned by the input embedding vector and further input noise, the synthesis neural network comprising:
one or more convolutional layers each configured to apply one or more convolutional filters to their respective input;
one or more further additive layers, each further additive layer configured to add a linear transformation of further input noise to the output of a convolutional layer; and
one or more combining layers, each combining layer configured to combine the output of a further addition layer with a linear transformation of the embedding vector.

14. The method of claim 1, further comprising updating parameters of the neural network in dependence on an objective function, the objective function determined based on the output data.

15. A computer implemented method comprising:
receiving, as input to a neural network, input data;
processing the input data through a plurality of neural network layers of the neural network to generate output data; and
outputting, from the neural network, the output data,
wherein the plurality of neural network layers comprises one or more polynomial product layers, each polynomial product layer configured to combine a respective first polynomial of the input data with a respective second polynomial of the input data.

16. The method of claim 15, wherein the plurality of neural network layers comprises:
a plurality of polynomial layers, each polynomial layer configured to generate one or more polynomials of its respective input, wherein the first and/or second respective polynomials of the input data are outputs of a corresponding polynomial layer, each polynomial layer comprising:
an input layer applying a plurality of linear transformations to the respective input of the polynomial layer,
one or more Hadamard layers, each Hadamard layer configured to apply a Hadamard product between a first input to said Hadamard layer and a second input to said Hadamard layer, wherein the first input to each Hadamard layer of the corresponding polynomial layer is a respective linear transformation of the input of said polynomial layer and the second input to each Hadamard layer is the output of a previous layer in said polynomial layer; and
one or more additive layers, each additive layer configured to add output of a Hadamard layer with output of another layer of the neural network.

17. The method of claim 15, wherein the plurality of neural network layers comprises:
a plurality of polynomial layers, each polynomial layer configured to generate one or more polynomials of its respective input, wherein the first and/or second respective polynomials of the input data are outputs of a corresponding polynomial layer, each polynomial layer comprising:
an input layer applying a plurality of linear transformations to the respective input of the polynomial layer,
a first Hadamard layer configured to apply a Hadamard product between an output of the input layer and a linear transformation of a learned parameter;
one or more further Hadamard layers, each further Hadamard layer configured to apply a Hadamard product between a first input to said subsequent Hadamard layer and a second input to said Hadamard layer wherein the first input to each further Hadamard layer of the corresponding polynomial layer is a respective linear transformation of the input of said polynomial layer and the second input to each further Hadamard layer is the output of a previous layer in said polynomial layer; and
one or more additive layers, each additive layer configured to add output of a Hadamard layer with output of another layer of the neural network.

18. The method of claim 15, wherein the plurality of neural network layers comprises:
a first plurality of polynomial layers, each first polynomial layer configured to generate one or more polynomials of its respective input, wherein the first respective polynomials of the input data are outputs of a corresponding first polynomial layer, each first polynomial layer comprising:
an input layer applying a plurality of linear transformations to the respective input of the polynomial layer,
one or more Hadamard layers, each Hadamard layer configured to apply a Hadamard product between a first input to said Hadamard layer and a second input to said Hadamard layer, wherein the first input to each Hadamard layer of the corresponding polynomial layer is a respective linear transformation of the input of said polynomial layer and the second input to each Hadamard layer is the output of a previous layer in said polynomial layer; and
one or more additive layers, each additive layer configured to add output of a Hadamard layer with output of another layer of the neural network; and
a second plurality of polynomial layers, each second polynomial layer configured to generate one or more polynomials of its respective input, wherein the second respective polynomials of the input data are outputs of a corresponding second polynomial layer, each second polynomial layer comprising:
an input layer applying a plurality of linear transformations to the respective input of the polynomial layer,
a first Hadamard layer configured to apply a Hadamard product between an output of the input layer and a linear transformation of a learned parameter;
one or more further Hadamard layers, each further Hadamard layer configured to apply a Hadamard product between a first input to said subsequent Hadamard layer and a second input to said Hadamard layer, wherein the first input to each further Hadamard layer of the corresponding polynomial layer is a respective linear transformation of the input of said polynomial layer and the second input to each further Hadamard layer is the output of a previous layer in said polynomial layer; and
one or more additive layers, each additive layer configured to add output of a Hadamard layer with output of another layer of the neural network.

19. A system comprising:
one or more processors; and
one or more non-transitory computer-readable media that collectively store instructions that, when executed by the one or more processors, cause the computing system to perform operations, the operations comprising:
receiving, as input to a neural network, input data;
processing the input data through a plurality of neural network layers of the neural network to generate output data; and
outputting, from the neural network, the output data,
wherein the plurality of neural network layers comprises a plurality of polynomial layers, each polynomial layer configured to generate one or more polynomials of its respective input, each polynomial layer comprising:
one or more product layers, each product layer configured to generate a product of two inputs to said product layer; and
one or more additive layers, each additive layer configured to add output of a product layer with output of another layer of the neural network.

20. A non-transitory computer readable medium containing instructions thereon which, when executed by one or more computing devices, causes the one or more computing devices to perform a method comprising:
receiving, as input to a neural network, input data;
processing the input data through a plurality of neural network layers of the neural network to generate output data; and
outputting, from the neural network, the output data,
wherein the plurality of neural network layers comprises a plurality of polynomial layers, each polynomial layer configured to generate one or more polynomials of its respective input, each polynomial layer comprising:
one or more product layers, each product layer configured to generate a product of two inputs to said product layer; and
one or more additive layers, each additive layer configured to add output of a product layer with output of another layer of the neural network.
